(19) United States
(12) Patent Application Publication
(10) Pub. No.: US 2006/0067347 A1
(43) Pub. Date: Mar. 30, 2006

(54) Cell-based queue management in software

(76) Inventors: Uday Naik, Fremont, CA (US); Alok Kumar, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/953,159

(22) Filed: Sep. 29, 2004

(51) Int. Cl. G06F 3/00; H04L 12/28

(52) U.S. Cl. 370/412; 710/3; 710/20; 710/52

(57) ABSTRACT

A system and method to implement cell-based queue management in software. Packets are received from a packet-based medium. In response, packet pointers are enqueued into a virtual output queue (“VOQ”). When a dequeue request to dequeue a cell for the VOQ is received, one of the packet pointers is speculatively prefetched from the VOQ. A cell is then transmitted onto a cell-based fabric containing at least a portion of one of the packets received from the medium and designated by a current packet pointer from among the packet pointers of the VOQ.

### TECHNICAL FIELD

This disclosure relates generally to networking, and in particular but not exclusively, relates to cell-based queue management in software.

### BACKGROUND INFORMATION

Networks of different types may be coupled together at boundary nodes to allow data from one network to flow to the next. In many cases, a patchwork of networks may transport data using different communication protocols. In this case, the boundary nodes must be capable of translating data received using one communication protocol into data from transmitting on the other communication protocol.

Once such example is when a router is coupled between a packet-based network (e.g., Ethernet executing internet protocol) and a cell based network (e.g., an asynchronous transfer mode (“ATM”) network, a common switch interface (“CSIX”) fabric, etc.). The router must be capable of packet segmentation to convert data carried within packets of variable length into data carried by cells of fixed size.

To transport data back-and-forth between the packet-based network and the cell-based network, a queue manager is executed to manage queues. Ingress flows from the packet-based network are queued into arrays. The queued data is then segmented and egress flows of cell-based data are transported onto the cell-based network. When these operations are executed at high-speed (e.g., OC-192 or the like), the queue arrays are implemented with expensive, immutable hardware based queue arrays, which relieve the queue manager of burdensome tasks, such as tracking the number of transmitted cells per packet.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a system for communicating between packet-based mediums and a cell-based switch fabric, in accordance with an embodiment of the present invention.

FIG. 2 is a block diagram illustrating a hardware system including a network processing unit to act as an intermediary between a packet-based medium and a cell-based switch fabric, in accordance with an embodiment of the present invention.

FIG. 3 is a block diagram illustrating functional blocks executed by a network processing unit to mediate between a packet-based medium and a cell-based switch fabric, in accordance with an embodiment of the present invention.

FIG. 4 is a block diagram illustrating software constructs maintained by a queue manager to manage virtual output queues, in accordance with an embodiment of the present invention.

FIG. 5 is a flow chart illustrating a process to enqueue and dequeue packet pointers to/from virtual output queues of a network processing unit along with corresponding demonstrative pseudo code, in accordance with an embodiment of the present invention.

FIG. 6 is a flow chart illustrating a process to transmit cells onto a switch fabric, in accordance with an embodiment of the present invention.

FIG. 7 illustrates demonstrative pseudo code to transmit cells onto a switch fabric, in accordance with an embodiment of the present invention.

### DETAILED DESCRIPTION

Embodiments of a system and method to manage virtual output queues in software are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

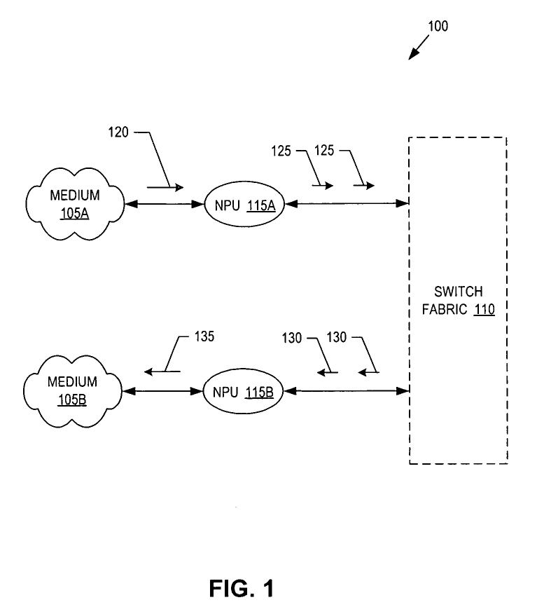

FIG. 1 is a block diagram illustrating a system 100 for communicating between packet-based mediums 105A and 105B and a cell-based switch fabric 110, in accordance with an embodiment of the present invention. A network processing unit (“NPU”) 115A is coupled between medium 105A and switch fabric 110. NPU 115A receives variable length packets 120, buffers packets 120, segments packets 120, and transmits the packet segments onto switch fabric 110 as cells 125. Correspondingly, NPU 115B receives cells 130 from switch fabric 110, buffers cells 130, reassembles cells 130, and transmits the cells onto medium 105B as variable length packets 135.

In one embodiment, the sizes of packets 120 and 135 may vary from as little as 40 bytes to as long as 9000 bytes, while the cells 125 and 130 may be fixed at 64, 128, or 256 bytes (or the like). As such, a single 9000 byte packet 120 may be segmented as many as 141 times to be transported across switch fabric 110 having 64 byte cells. Therefore, NPUs 115A and 115B must be capable of high-speed segmentation and reassembly (“SAR”) to avoid being a bottleneck between mediums 105A and 105B and switch fabric 110. SAR functionality can require time intensive read/write access to external memory, which is particularly problematic at high-speed optical carrier rates (e.g., OC-192). To alleviate read/prefetch bottlenecks, embodiments of the present invention issue multiple overlapping read/write requests to external memory. These read/prefetch requests are speculative in nature and leverage the architectural parallelism and multi-threading nature of NPUs 115A and 115B.

Mediums 105A and 105 may include any packet-based network, including but not limited to, Ethernet, a local area network (“LAN”), a wide area network (“WAN”), the Internet, and the like. Mediums 105A and 105B may execute any number of packet-based protocols such as Internet Protocol (“IP”), Transmission Control Protocol over IP (“TCP/IP”), User Datagram Protocol (“UDP”), and the like. Switch fabric 110 may include any cell-based switch fabric, such as an Asynchronous Transfer Mode (“ATM”) network, a Common Switch Interface (“CSIX”) fabric, an Advanced Switching (“AS”) network, and the like.

Although mediums 105A and 105B are illustrated as separate mediums, in one embodiment, mediums 105A and 105B are one in the same medium. Similarly, NPUs 115A and 115B could be a single physical NPU with NPU 115A representing the transmit side to switch fabric 110 and NPU 115B representing the receive side from switch fabric 110. In this embodiment, a single NPU is responsible for SAR functionality.

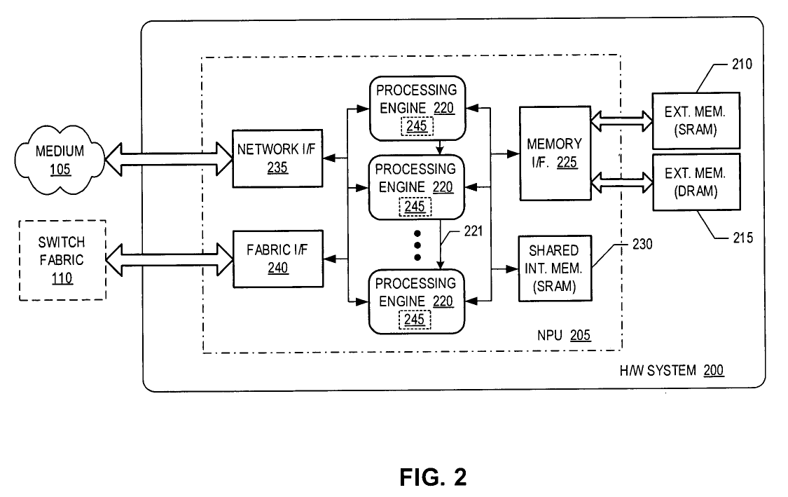

FIG. 2 is a block diagram illustrating a hardware system 200 including a NPU 205 to act as an intermediary between a packet-based medium and a cell-based switch fabric, in accordance with an embodiment of the present invention. NPU 205 is one embodiment of NPUs 115A and 115B. Hardware system 200 may represent any number of intermediary network devices, including a router, switch, hub, a network access point (“NAP”), and the like. In one embodiment, system 200 is an Internet Exchange Architecture (“IXA”) network device. The illustrated embodiment of hardware system 200 includes NPU 205 and external memories 210 and 215. The illustrated embodiment of NPU 205 includes processing engines 220 (a.k.a., micro-engines), a memory interface 225, shared internal memory 230, a network interface 235, and a fabric interface 240. Processing engines 220 may further include local memories 245.

The elements of NPU hardware system 200 are interconnected as follows. Processing engines 220 are coupled to network interface 235 to receive and transmit packets from/to medium 105 and coupled to fabric interface 240 to receive and transmit cells from/to switch fabric 110. In one embodiment, processing engines 220 may communicate with each other via a Next Neighbor Ring 221. Processing engines 220 are further coupled to access external memories 210 and 215 via memory interface 225 and shared internal memory 230. Memory interface 225 and shared internal memory 230 may be coupled to processing engines 245 via a single bus or multiple buses to minimize delays for external accesses.

Processing engines 220 may operate in parallel to achieve high data throughput. Typically, to ensure maximum processing power, each of processing engines 220 process multiple threads (e.g., eight threads) and can implement instantaneous context switching between threads. In one embodiment, processing engines 220 are pipelined and operate on one or more virtual output queues (“VOQs”) concurrently. In one embodiment, one or more VOQs are maintained within external memory 210 for enqueuing and dequeuing queue elements thereto/therefrom. In other embodiments, one or more VOQs or other data structures can be maintained within local memories 245, shared internal memory 230, and external memory 215.

In one embodiment, external memory 210 and shared internal memory 230 are implemented with static random access memory (“SRAM”) for fast access thereto. In one embodiment, external memory 215 is implemented with dynamic RAM (“DRAM”) to provide large volume, yet fast access memory. External memories 210 and 215, shared internal memory 230, and local memories 245 may each be implemented with any type of memory including, DRAM, synchronous DRAM (“SDRAM”), double data rate SDRAM (“DDR SDRAM”), SRAM, and the like. Although FIG. 2 only illustrates three processing engines 220, more or less processing engines 220 may be implemented as illustrated. It should be appreciated that various other elements of hardware system 200 have been excluded from. FIG. 2 and this discussion for the purposes of clarity.

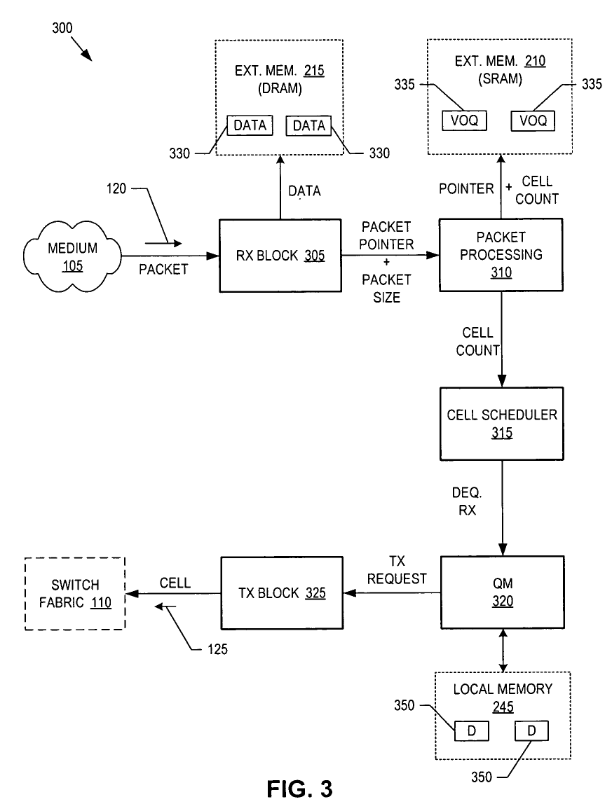

FIG. 3 is a block diagram illustrating a system 300 of functional blocks executed by NPU 205 to communicate data between medium 105 and switch fabric 110, in accordance with an embodiment of the present invention. The illustrated embodiment of system 300 includes a receive block 305, a packet processing block 310, a cell scheduler 315, a queue manager 320, and a transmit block 325. In one embodiment, each of receive block 305, a packet processing block 310, a cell scheduler 315, a queue manager 320, and a transmit block 325, are software code executed by one or more of processing engines 220. In one embodiment, queue manager 320 is executed by multiple threads of one of processing engines 220 and is therefore capable of parallel processing. In some embodiments, different threads of a single one of processing engines 220 may execute two or more functional blocks of system 300.

Receive block 305 receives packets 120 from medium 105. Receive block 305 parses out data 330 carried within each packet 120, stores data 330 to external memory 215, and generates a pointer designating the stored data 330. Receive block 305 may also count the number of bytes per packet 120 received and pass this information along with the pointer to packet processing block 310.

Packet processing block 310 processes the pointers based on a particular forwarding scheme enabled and classifies the pointers into one of VOQs 335. Packet processing block 310 may further compute a CELL_COUNT indicating the number of cells needed to transport data 330 from the received packet across switch fabric 110. In one embodiment, packet processing block 310 may simply divide the size of a cell (e.g., 64 bytes, 128 bytes, etc.) by the packet size provided by receive block 305. In one embodiment, the CELL_COUNT along with the pointer may be written into external memory 210 as a packet pointer by packet processing 310.

Cell scheduler 315 indicates to queue manager 320 that a packet has arrived and is waiting to have its corresponding packet pointer enqueued into one of VOQs 335. Each VOQ 335 may store packet pointers generated from a single ingress flow from medium 105 or multiplex multiple ingress flows sharing common characteristics (e.g., common source and destination points, quality of service, etc.) into a single VOQ 335. Queue manager 320 issues write requests to external memory 210 to enqueue packet pointers into one of VOQs 335.

Cell scheduler 315 further receives the CELL_COUNT from packet processing 310 and then schedules transmission slots for each cell of a received packet. Cell scheduler 315, based on its configured scheduling policy, notifies queue manager 320 when to dequeue a packet pointer from one of VOQs 335 for transmission. In response, queue manager 320 speculatively prefetches packet pointers from VOQs 335 into its local memory 245. Queue manager 320 then dequeues cells of the prefetched packet pointers from VOQs 335 in the order indicated by cell scheduler 315. In one embodiment, queue manager 320 generates a VOQ descriptor file 250 within local memory 245 for each VOQ 335. Queue manager 320 maintains VOQ descriptor files 250 in order to track the current packets having cells dequeued therefrom, cells remaining to dequeue from the current packets, a VOQ size, a dequeue count, a head index, and a tail index. Once queue manager 320 dequeues a cell from the current packet, it passes the current packet pointer to transmit block 325.

Transmit block 325 retrieves segments of data 330 (i.e., segments of received packets 120) corresponding to each cell to be transmitted. Transmit block 325 then transmits each cell 125 containing a packet segment onto switch fabric 110.

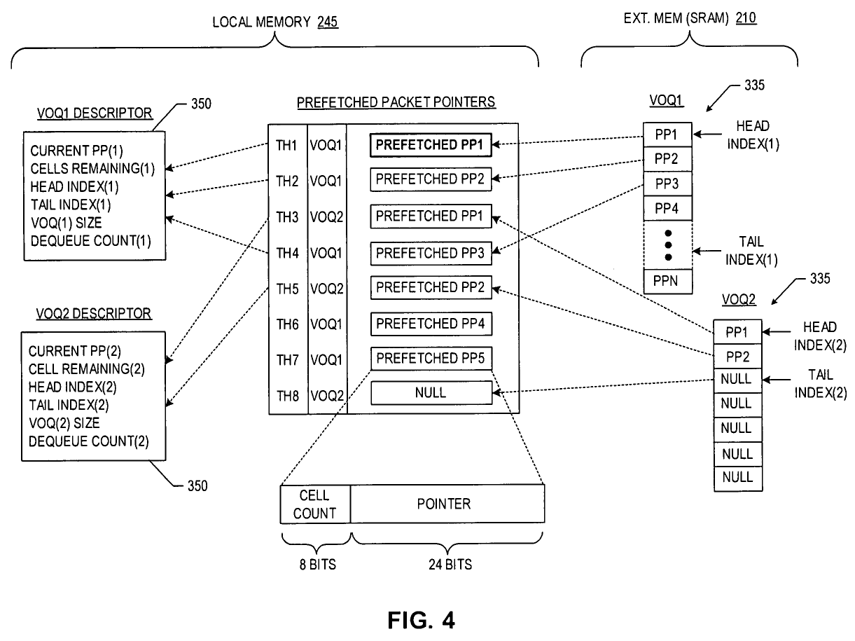

FIG. 4 is a block diagram illustrating software constructs maintained by queue manager 320 to manage VOQs 335, in accordance with an embodiment of the present invention. FIG. 4 illustrates an embodiment of queue manager 320 having eight independent threads TH1 through TH8 each capable of prefetching a packet pointer (“PP”) from one of VOQ1 or VOQ2. FIG. 4 further illustrates PP1 through PPN queued within VOQ1 and PP1 and PP2 queued within VOQ2. VOQ2 is further illustrated as having a number of NULL PP. These NULL PP represent empty or otherwise invalid slots of VOQ2 not currently being used. Queue manager 320 maintains a VOQ1 descriptor file and a VOQ2 descriptor file in local memory 245 corresponding to each of VOQs 335. Each VOQ descriptor file 350 includes a CURRENT_PP, a CELLS_REMAINING counter, a HEAD_INDEX, a TAIL_INDEX, a VOQ_SIZE counter, and a DEQUEUE_COUNT counter. The use of VOQ descriptor files 350 to manage VOQs 335 will be discussed below.

By way of example and not limitation, in a single round, cell scheduler 315 may schedule five cells from VOQ1 to dequeue and three cells from VOQ2 to dequeue. In response, threads TH1-TH8 will speculatively prefetch five packet pointers from VOQ1 and three packet pointers from VOQ2. For example, TH1, TH2, TH4, TH6, and TH7 may each speculatively prefetch packet pointers PP1, PP2, PP3, PP4, and PP5 from VOQ1, respectively. Similarly, threads TH3, TH5, and TH8 may each speculatively prefetch packet pointers PP1, PP2, and a NULL packet pointer from VOQ2, respectively. Each thread consecutively issues a read request from external memory 210 to speculatively prefetch a packet pointer in response to a request from cell scheduler 315 to dequeue a cell from one of VOQs 335. For example, after thread TH1 issues a read request, thread TH1 relinquishes control of queue manager 320 to thread TH2, which then issues its read request, and so on. As each thread takes control of queue manager 320 to issue read/write requests, the particular thread updates one of VOQ descriptor files 350 corresponding to the particular VOQ 335 it is currently working on to coordinate enqueue/dequeue operations from a single VOQ between multiple threads.

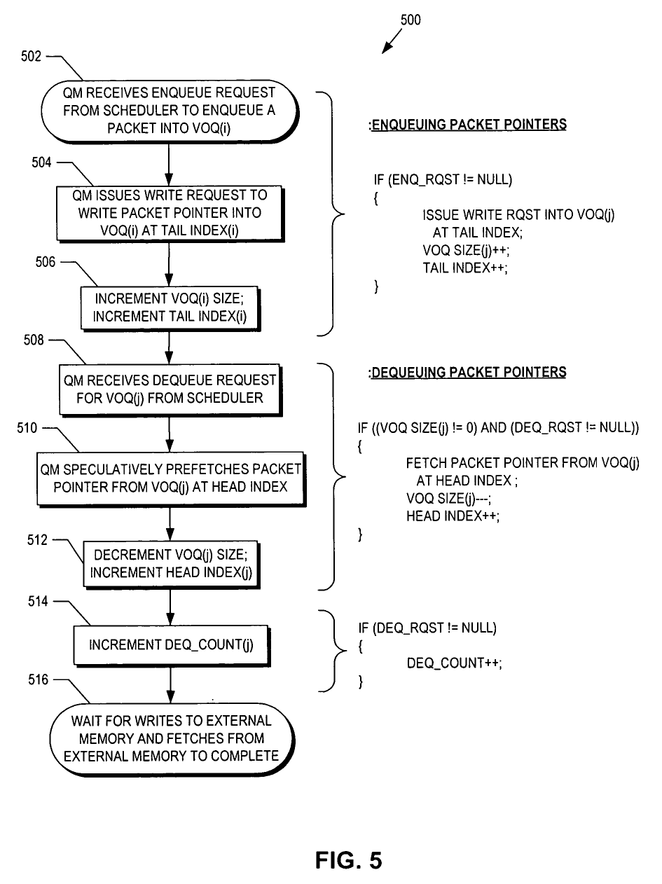

In one embodiment, after each thread TH1 through TH8 issues a read request all threads wait until all packet pointers have been prefetched into local memory 245. At this point, thread TH1 may commence dequeuing cells from the current packet designated by PP1 from VOQ1. If the packet designated by PP1 from VOQ1 contains more than five cells, then thread TH1 will dequeue five cells, update the VOQ1 descriptor file and relinquish control to thread TH2. Thread TH2 will determine that five cells have already been dequeued from VOQ1 by referencing the VOQ1 descriptor file and therefore not dequeue anymore cells from VOQ1. Instead, thread TH2 will drop the prefeteched PP2 and relinquish control to thread TH3. A detailed discussion of the coordination procedures for enqueuing and dequeuing cells to/from VOQs 335 follows below in connection with FIGS. 5, 6, and 7.

The processes explained below are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

FIG. 5 is a flow chart illustrating a first portion of a process 500 to enqueue and dequeue packet pointers to/from VOQs 335 along with corresponding demonstrative pseudo code, in accordance with an embodiment of the present invention. Process 500 is executed and repeated by each thread (e.g., threads TH1 through TH8) executing on queue manager 320.

In a process block 502, queue manager 320 receives an enqueue request from scheduler 315 to enqueue a packet pointer into a VOQ(i) (e.g., VOQ1 or VOQ1). As described above, scheduler 315 schedules an enqueue request in response to packet 120 arriving from medium 105. In a process block 504, the thread of queue manager 320 managing the enqueue request, issues a write request to write the packet pointer into the VOQ(i) at the slot position indicated by the TAIL_INDEX(i) of the corresponding VOQ(i) descriptor file 350. In connection with issuing the write request, the particular thread of queue manager 320 increments the VOQ(i)_SIZE indicating that the VOQ(i) is now buffering one additional packet pointer and increments the TAIL_INDEX(i) so that the next enqueued packet pointer is written into the next empty VOQ(i) slot (process block 506).

In a process block 508, queue manager 320 receives a dequeue request from scheduler 315 to dequeue a cell from a VOQ(j). In response to the request to dequeue a “cell”, a thread of queue manager 320 speculatively prefetches an entire “packet pointer” located at the HEAD_INDEX(j) of VOQ(j) into local memory 245 as a prefetched PP (process block 510). The thread determines the correct HEAD_INDEX by referencing the VOQ(j) descriptor file. In connection with prefetching the packet pointer, the particular thread also decrements the VOQ(j)_SIZE to indicate that a packet pointer has been removed from the VOQ(j) and increments the HEAD_INDEX(j) to advance the HEAD_INDEX(j) to the next slot of VOQ(j) (process block 512). In a process block 514, the DEQUEUE_COUNT(j) is also incremented by the particular thread of queue manager 320 to indicate that the VOQ(j) now has another cell pending for transmission onto switch fabric 110.

As mentioned above, process 500 is executed by each thread of queue manager 320 actively dedicated to dequeuing cells from VOQs 335. As such, each of threads TH1 through TH8 will consecutively cycle through process blocks 502 through 514. Once each thread reaches a process block 516, it waits for all issued fetches from by the other threads to complete. A prefetch round is complete once all fetches have completed. In this manner, a number of packet pointers are speculatively prefetched into local memory 245 whether or not all the packet pointers pointer will be used. Since each thread prefetches an entire packet pointers in response to a request only to dequeue a cell, one or more packet pointers may not be used in a given round if one packet pointers references a packet requiring multiple cells to transmit across switch fabric 110.

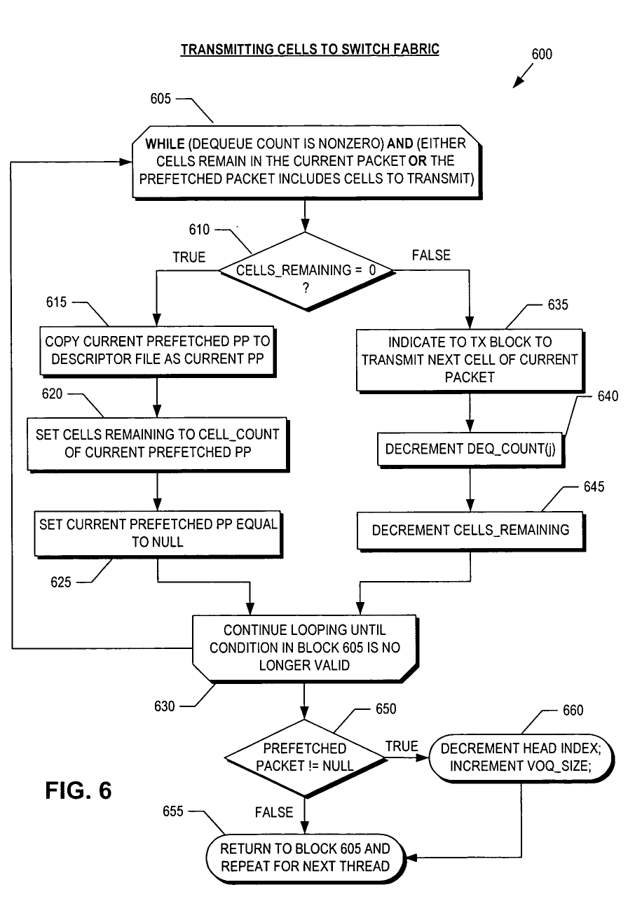

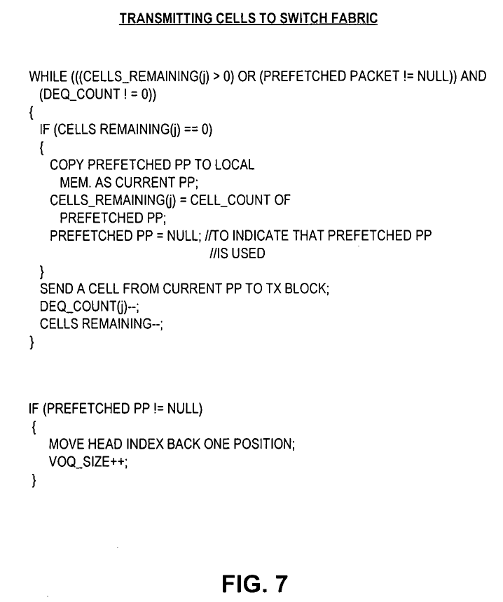

FIG. 6 is a flow chart illustrating a process 600 for transmitting dequeued cells onto switch fabric 110, in accordance with an embodiment of the present invention. Corresponding demonstrative pseudo code for transmitting cells onto switch fabric 110 is provided in FIG. 7.

Once the packet pointers prefetches from external memory 210 to local memory 245 are complete, thread TH1 can commence issuing transmission requests for the dequeued cells. In a process block 605, thread TH1 determines whether DEQUEUE_COUNT(j) is nonzero AND (if either the CELLS_REMAINING(j) counter is nonzero OR the prefetched PP1 includes cells to transmit (i.e., prefetched PP1 is not NULL)). The CELLS_REMAINING(j) counter references the number of cells within the CURRENT_PP that have not yet been transmitted onto switch fabric 110, while the prefetched PP1 refers to the packet pointers prefetched by thread TH1 and stored in local memory 245.

In a decision block 610, if the CELLS_REMAINING(j) counter equals zero, then process 600 continues to a process block 615. In process block 615, the prefetched PP1 is copied into the VOQ1 descriptor file as the CURRENT_PP(j). In a process block 620, the CELLS_REMAINING(j) counter is set to the CELL_COUNT extracted from the prefetched PP1. Next, the prefechted PP1 is set to NULL to indicate that the prefetched PP1 has been used up (process block 625).

In a process block 630, process 600 loops back to process block 605 as long as the conditions of process block 605 remain valid. In the example of FIG. 4, DEQUEUE_COUNT(1) is five and CELLS_REMAINING(1) is now equal to CELL_COUNT. Since CELLS_REMAINING(1) is nonzero, process 600 continues to a process block 635.

In process block 635, queue manager 320 indicates to TX block 325 to transmit the next cell of the current packet designated by the CURRENT_PP(j). In connection with transmitting the next cell of the current packet, queue manager 320 decrements the DEQUEUE_COUNT(j) to indicate that the number of cells to dequeue for VOQ(j) is now one less (process block 640). Similarly, queue manager 320 decrements the CELLS_REMAINING(j) counter indicating that there is now one less cell remaining to transmit of the current packet designated by the CURRENT_PP (process block 645).

After process block 645, process 600 again returns to process block 630. Process 600 will continue to loop back to process block 605 as long as the DEQUEUE_COUNT is nonzero and either (1) the CELLS_REMAINING counter is nonzero or (2) the prefetched PP is not NULL. If the condition of process block 605 is no longer valid, then process 600 continues to a decision block 650.

Decision block 650 determines whether the prefetched PP is NULL. If the prefetched PP is equal to NULL, then the prefetched PP is either a speculatively prefetched NULL packet pointer having no cells to transmit or the prefetched PP was copied to the VOQ(j) descriptor file as the CURRENT_PP and has therefore been used up. In either case, process 600 will return to process block 605 (process block 655) and repeat for the next thread. Process 600 will continue to return to process block 605 until all threads (e.g., threads TH1-TH8) have executed. Once all threads have executed, the current round is complete and process 600 will start over again with thread TH1.

Returning to decision block 650, if the prefetched PP is determined to be non-NULL (i.e., the prefetched PP has not been used up and cells remain pending for transmission), then process 600 continues to a process block 660. In process block 660, the HEAD_INDEX(j) is decremented or backed up one position so that the current prefetched PP is refetched in a subsequent round. Additionally, the VOQ(j)_SIZE is incremented since the speculatively prefetched PP is returned to the VOQ(j) to be speculatively refetched again in a subsequent round.

Embodiments of the present invention enable VOQs 335 to be maintained in software queues without need of a hardware queue array. Further, VOQs 335 can be entirely managed by a software entity (e.g., queue manager 320). As such, the techniques described herein are flexible, can be updated after deployment, and do not require the expense of a hardware queue array. As the maximum transmission unit (“MTU”) size of packet-based networks increases, the capacity of software based queue management can scale appropriately. In contrast, hardware queue arrays are immutable devices incapable of scaling. For example, a hardware queue array may only have six bits allocated to maintain the CELL_COUNT value. Therefore, the cell size of the cell-based network must be capable of transmitting the largest packet received from the packet-based network within 64 cells (e.g., 2⁶=64), possibly requiring selection of a larger than desired cell size, or unduly limiting the MTU of the packet-based network.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
enqueuing packet pointers into a virtual output queue (“VOQ”) in response to receiving packets from a packet-based medium;
speculatively prefetching one of the packet pointers from the VOQ in response to a dequeue request to dequeue a cell for the VOQ; and
transmitting the cell onto a cell-based fabric containing at least a portion of one of the packets received from the medium and designated by a current packet pointer from among the packet pointers of the VOQ.

2. The method of claim 1, further comprising:
incrementing a dequeue count for each of the packet pointers speculatively prefetched from the VOQ; and
decrementing the dequeue count for each cell transmitted for the VOQ.

3. The method of claim 2, wherein transmitting the cells onto the fabric comprises transmitting the cells onto the fabric while the dequeue count remains nonzero.

4. The method of claim 3, further comprising tracking cells remaining to transmit from the packet designated by the current packet pointer and wherein transmitting the cells onto the fabric further comprises transmitting the cells onto the fabric while the dequeue count remains nonzero and at least one of the cells remaining to transmit remains nonzero and a next prefetched packet pointer designates a next packet having cells to transmit.

5. The method of claim 1, further comprising:
enqueuing the packet pointers into multiple VOQs;
speculatively prefetching the packet pointers from the multiple VOQs in response to dequeue requests to dequeue cells from the multiple VOQs;
generating multiple current packet pointers each corresponding to one of the multiple VOQs; and
transmitting the cells onto the fabric each containing at least a portion of one of the packets received from the medium and designated by a corresponding current packet pointer.

6. The method of claim 5, wherein the packet pointers are sequentially speculatively prefetched each by a different thread of a processing engine and wherein transmitting the cells is executed after a last one of the different threads completes speculatively prefetching a corresponding one of the packet pointers.

7. The method of claim 6, further comprising maintaining a VOQ descriptor file for each of the multiple VOQs, the VOQ descriptor file including a corresponding one of the multiple current packet pointers, a corresponding count of the cells remaining to transmit within a corresponding current packet, and a corresponding dequeue count.

8. The method of claim 1, wherein the VOQ is maintained in external memory and the one of the packet pointers is speculatively prefetched into local memory.

9. A machine-accessible medium that provides instructions that, if executed by a machine, will cause the machine to perform operations comprising:
prefetching packet pointers from virtual output queues (“VOQs”) in response to dequeue requests to dequeue at least one cell for each of the VOQs, the packet pointers designating corresponding packets received from a packet-based network;
waiting until a last one of the packet pointers is prefetched; and
transmitting at least one cell onto a cell-based network, including at least a portion of one of the packets, for each of the VOQs.

10. The machine-accessible medium of claim 9, further providing instructions that, if executed by the machine, will cause the machine to perform further operations, comprising:
incrementing dequeue counters for each of the packet pointers prefetched from corresponding VOQs, each dequeue counter corresponding to one of the VOQs; and
decrementing each of the dequeue counters for each cell transmitted for each of the VOQs.

11. The machine-accessible medium of claim 10, wherein transmitting the cells each including at least a portion of one of the packets comprises transmitting the cells for each of the VOQs while a corresponding one of the dequeue counters remains nonzero.

12. The machine-accessible medium of claim 11, wherein each of the packet pointers is prefetched from a corresponding one of the VOQs by different threads and wherein waiting until the last one of the packet pointers is prefetched comprises waiting until a last one of the different threads prefetches the last one of the packet pointers.

13. The machine-accessible medium of claim 12, wherein a single one of the different threads dequeues multiple cells for a single one of the VOQs in response to multiple dequeue requests for the one of the VOQs, if a prefetched packet pointer corresponding to the one of the VOQs designates a packet requiring multiple cells to transmit.

14. The machine-accessible medium of claim 10, further providing instructions that, if executed by the machine, will cause the machine to perform further operations, comprising:
generating VOQ descriptor files corresponding to each of the VOQs, each of the VOQ descriptor files including one of the dequeue counters, a cells remaining counter, and a current packet pointer, the current packet pointer designating a current packet from among the packets from which cells corresponding to one of the VOQs are currently transmitted, the cells remaining counter indicating a number of cells within the current packet not yet transmitted.

15. The machine-accessible medium of claim 14, wherein transmitting the cells each including at least a portion of one of the packets comprises transmitting the cells for each of the VOQs while the corresponding one of the dequeue counters remains nonzero and at least one of the cells remaining counter is nonzero and a next one of the prefetched packet pointers for a particular one of the VOQs includes cells to transmit.

16. A system, comprising:
a first processing engine to execute a receive block to receive packets from a packet-based network;
external static random access memory (“SRAM”) coupled to store virtual output queues (“VOQs”) of packet pointers designating the packets received from the network;
a second processing engine coupled to the external SRAM, the second processing engine to execute a queue manager to manage the VOQs, the queue manager to prefetch the packet pointers from the VOQs in response to dequeue requests to dequeue at least one cell fro each of the VOQs; and
a third processing engine coupled to execute a transmit block to transmit the cells to a cell-based fabric, each of the cells including at least a portion of one of the packets received from the network.

17. The system of claim 16, wherein the third processing engine coupled to wait until a last one of the packet pointers is prefetched before the transmitting the cells to the fabric.

18. The system of claim 17, wherein the second processing engine maintains a dequeue counter for each of the VOQs, and wherein the second processing engine is coupled to increment each dequeue counter for each packet pointer prefetched from a corresponding one of the VOQs, and wherein the second processing engine is further coupled to decrement each dequeue counter for each cell transmitted for a corresponding one of the VOQs.

19. The system of claim 18, wherein the third processing engine is coupled to transmit the cells for each of the VOQs onto the fabric while a corresponding one of the dequeue counters remains nonzero.

20. The system of claim 16, wherein the second processing engine comprises a multithreaded processing engine, each thread of the multithreaded processing engine to speculatively prefetch one of the packet pointers in response to one of the dequeue requests.

21. The system of claim 20, further comprising a fourth processing engine coupled to execute a scheduler, the scheduler to generate the dequeue requests.

22. The system of claim 16, wherein the packet-based network comprises an optical carrier network.

23. The system of claim 16, wherein the system comprises a network processing unit.

24. The system of claim 16, wherein the second processing engine includes local memory, the second processing engine to prefetch the packet pointers from the external SRAM into the local memory.
